(19) United States
(12) Patent Application Publication
(10) Pub. No.: US 2007/0166208 A1
(43) Pub. Date: Jul. 19, 2007

(54) HOT-AIR BLOWER

(75) Inventors: Hideki TANAKA, Hikone (JP); Fumio MIHARA, Kyoto (JP); Tomoya ISHIKAWA, Hikone (JP); Yasunori MATSUI, Hirakata (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/623,897

(22) Filed: Jan. 17, 2007

(30) Foreign Application Priority Data
Jan. 19, 2006 (JP) 2006-011645

(51) Int. Cl. B01J 19/08

(52) U.S. Cl. 422/186.04

(57) ABSTRACT

A radiation flow passage is branched from a main air flow passage extending from a fan in a main unit block toward a heater, an electrostatic atomization block is disposed in the radiation flow passage, and a section of the radiation flow passage positioned on a downstream side of a radiating unit is branched to a first branched flow passage passing through a discharge electrode to communicate with outside and a second branched flow passage bypassing the discharge electrode to communicate with the outside, so that the air around the discharge electrode is always ventilated to facilitate generation of water droplets, and portion of the air introduced into the radiation flow passage is supplied to the discharge electrode by the first branched flow passage to suppress lowering of cooling efficiency of the discharge electrode, so that nanometer-sized mist can be stably generated.

### CROSS REFERENCE TO RELATED APPLICATION

This application is based upon and claims the benefit of priority from a Japanese Patent Application No. 2006-011645, filed on Jan. 19, 2006; the entire contents of which are incorporated herein by reference.

### BACKGROUND OF THE INVENTION

1. Field of the Invention

The present invention relates to a hot-air blower with an electrostatic atomization function.

2. Description of the Related Art

As a conventional hot-air blower with an electrostatic atomization function, there is a hair dryer, for example. The hair dryer has a structure that an intake port and a discharge port are formed in a housing, and a heater is disposed at a downstream side of an airflow passage that takes in external air from the intake port by a fan and discharges the air from the discharge port, so that the air is heated by the heater and hot air is discharged from the discharge port, and it also has a structure that an ion generator is disposed in an ion flow passage branched from the air flow passage, so that negative ion generated in the ion generator is discharged from an ion discharge port (for example, see Japanese Patent Application Laid-open No. 2002-191426 (pp. 3 and FIG. 1)).

In the hot-air blower with an ion generator, ionic mist that imparts moisture to hair or the like is generated according to adhesion of mist to negative ion generated in the ion generator, where moisture for generating ionic mist is obtained by cooling ambient air around a discharge electrode for generating negative ion down to a temperature of a dew point or less to cause moisture in the air to condense on the discharge electrode.

Water droplets condensed on the discharge electrode are discharged as ionic mist together with the air introduced into the ion flow passage by applying high voltage between the discharge electrode and an opposite electrode. In this case, however, there is a possibility that, when the whole airflow in the ion flow passage is caused to flow to the discharge electrode, the discharge electrode is heated by the airflow and cooling efficiency for the discharge electrode is lowered, so that generation of nanometer-sized mist becomes unstable.

In view of the above problem, the present invention provides a hot-air blower that can generate nanometer-sized ionic mist more stably when cooling a discharge electrode to generate ionic mist from moisture in the air.

### SUMMARY OF THE INVENTION

An first aspect of the present invention provides a hot-air blower comprising: a main unit block having a blowing unit that takes external air from the intake port to discharge the same from the discharge port, and a heating unit that heats air at a downstream side of the blowing unit; and an electrostatic atomization block having a discharge electrode and an opposite electrode that are in pairs, a cooling unit that cools the discharge electrode to make water dew condensed, and a radiating unit that radiates heat from the cooling unit, where water held on the discharge electrode is atomized by applying high voltage between the discharge electrode and the opposite electrode, wherein blowing of hot air can be made possible by the main unit block, and generation of ionic mist is made possible by the electrostatic atomization block, and wherein a radiation flow passage facing the radiating unit is branched from a main air flow passage extending from the blowing unit of the main unit block toward the heating unit, and the radiation flow passage is branched to a first branched flow passage passing through the discharge electrode to communicate with outside and a second branched flow passage bypassing the discharge electrode to communicate with the outside.

It is preferable that an air supply adjusting unit that adjusts a direction and a volume of air reaching the discharge electrode is provided in the first branched flow passage.

It is preferable that the air supply adjusting unit sets an air flow passage reaching the discharge electrode to one direction or a plurality of directions.

It is preferable that the air supply adjusting unit is a shielding member that partially closes an air flow passage reaching the discharge electrode.

It is preferable that a discharge side of the second branched flow passage communicates with the main air flow passage in the main unit block.

### BRIEF DESCRIPTION OF THE DRAWINGS

FIG. 1 is a side view of a dryer that is one example of a hot-air blower according to a first embodiment of the present invention;

FIG. 2 is a front view of the dryer according to the first embodiment;

FIG. 3 is an enlarged sectional view taken along the line III-III in FIG. 2;

FIG. 4 is an enlarged sectional view of a portion A in FIG. 3; and

FIG. 5 is an enlarged sectional view of relevant parts of a dryer according to a second embodiment of the present invention, in the similar view of FIG. 4.

### DETAILED DESCRIPTION OF THE PREFERRED EMBODIMENTS

### First Embodiment

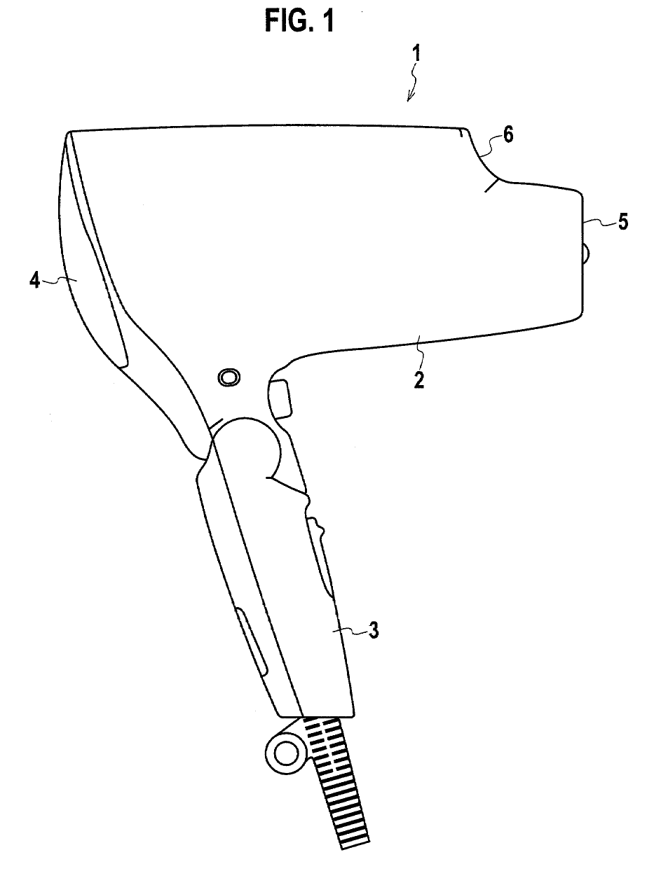

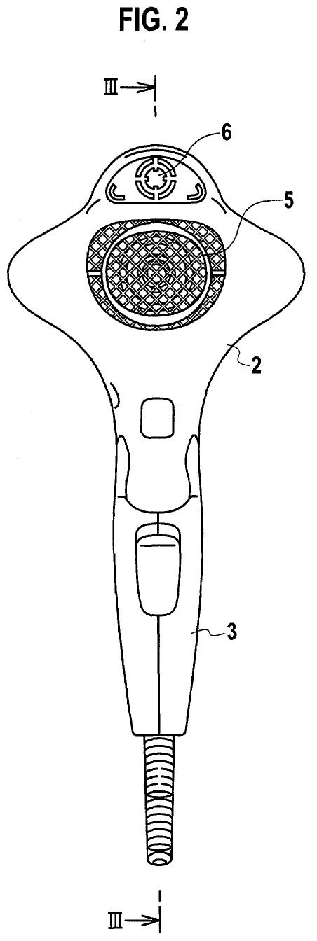

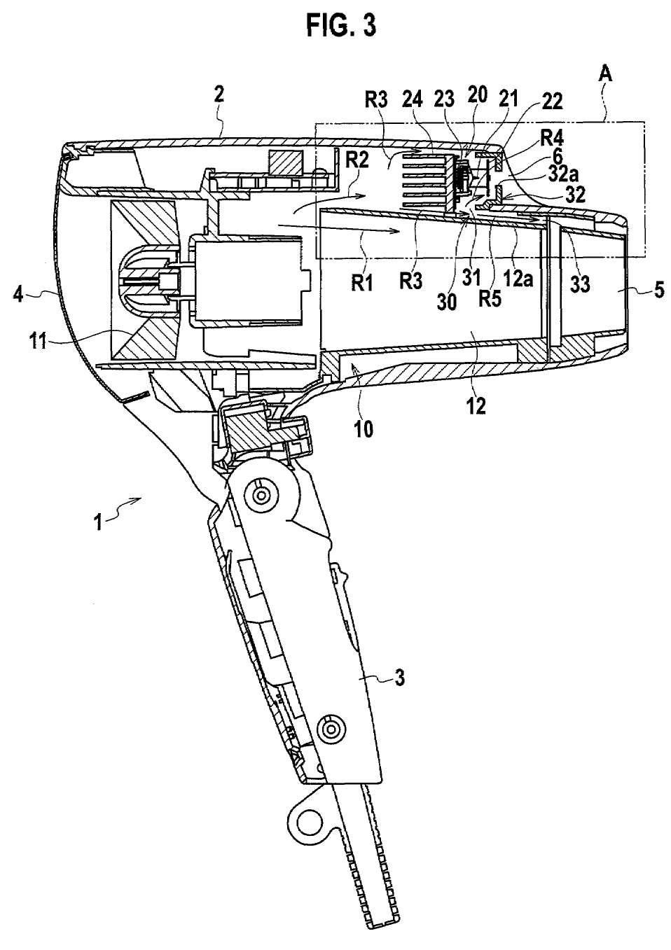

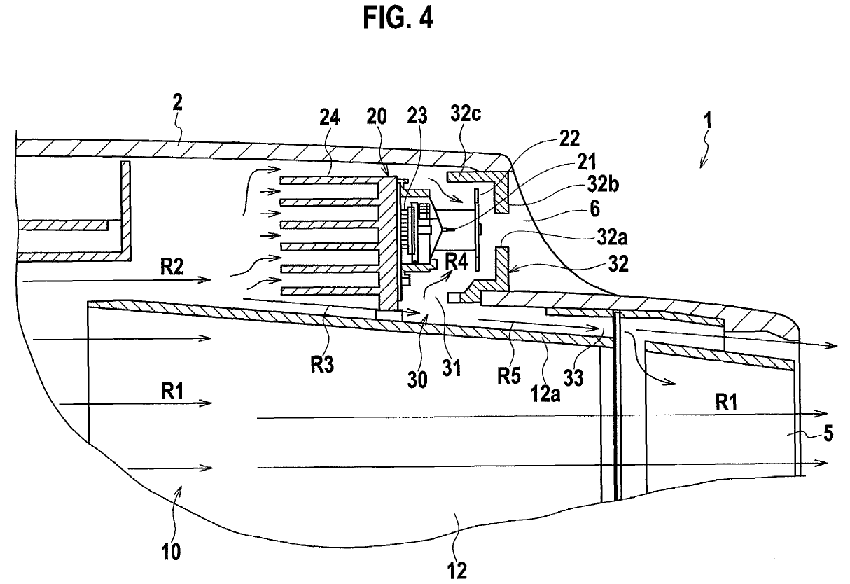

FIG. 1 is a side view of a dryer that is one example of a hot-air blower, FIG. 2 is a front view of the dryer, FIG. 3 is an enlarged sectional view of the dryer taken along the line III-III in FIG. 2, and FIG. 4 is an enlarged sectional view of a portion A in FIG. 3.

As shown in FIGS. 1 and 2, in a dryer 1 as a hot-air blower according to the present embodiment, a grip 3 is foldably attached to a lower portion of a housing 2, an intake port 4 is formed at a rear end portion of the housing 2, and a discharge port 5 is formed at a distal end of the housing 2. A discharge port 6 for ionic mist is also formed at an upper end portion of the housing 2 so as face in the same direction as the discharge port 5.

As shown in FIG. 3, a main unit block 10, which includes a fan 11 serving as a blowing unit, taking in external air from the intake port 4 to discharge the same from the discharge port 5, and a heater 12 serving as a heating unit, provided at a downstream of the fan 11 to heat the air, is provided inside the housing 2.

An electrostatic atomization block 20, which includes a discharge electrode 21 and an opposite electrode 22 that are in pairs, a cooling unit 23 that cools the discharge electrode 21 to make water dew condensed on the discharge electrode 21, and a radiating unit 24 that radiates generated heat of the cooling unit 23, where water held on the discharge electrode 21 is atomized by applying high voltage between the discharge electrode 21 and the opposite electrode 22, is provided inside the housing 2.

The cooling unit 23 is configured, for example, using a cooling element such as a Peltier device and it cools the discharge electrode 21 according to the Peltier effect obtained by current conduction thereto. The radiating unit 24 is configured by radiating fins provided on a radiation face of the cooling unit 23, and it prevents lowering of the cooling effect obtained by the discharge electrode 21 by radiating, by the radiating unit 24, heat quantity generated when the discharge electrode 21 is cooled by the cooling unit 23.

Water vapor in the air is condensed on a surface of the discharge electrode 21 as water droplets by cooling the discharge electrode 21 by the cooling unit 23 to cool the air around the discharge electrode 21 and lower the temperature of the air down to a dew point temperature or less in this manner.

At this time, water droplets adhered on the discharge electrode 21 are scattered in the air, accompanying minus charge by applying high voltage between the discharge electrode 21 and the opposite electrode 22 such that the discharge electrode 21 serves a minus electrode and charges concentrate thereon, and nano-sized ionic mist of about 3 to 100 nm can be finally generated while the water droplets repeat Rayleigh scattering during drifting in a high electric field.

Accordingly, hot air can be blown from the discharge port 5 and ionic mist generated in the electrostatic atomization block 20 can be discharged from the discharge port 6 by driving the fan 11 and supplying current to the heater 12.

In the present embodiment, as also shown in FIG. 4, a radiation flow passage R2 is branched from a main air flow passage R1 extending from the fan 11 in the main unit block 10 toward the heater 12, the electrostatic atomization block 20 is disposed in the radiation flow passage R2, and a section of the radiation flow passage R2 positioned at a downstream side of the radiating unit 24 is branched to a first branched flow passage R4 passing through the discharge electrode 21 to communicate with the outside and a second branched flow passage R5 bypassing the discharge electrode 21 to communicate with the outside.

The radiating unit 24 is disposed in the radiation flow passage R2 at the most upstream side thereof, and the cooling unit 23, the discharge electrode 21, and the opposite electrode 22 are disposed toward a downstream side of the radiation flow passage R2 in this order thereof. The radiation flow passage R2 communicates with the first and second branched flow passages R4 and R5 via an air flow passage R3 formed around the radiating unit 24.

An air supply adjusting unit 30 that adjusts a direction and a volume of the air drifting near the discharge electrode 21 is provided in the first branching flow passage R4. The air supply adjusting unit 30 includes a cover portion 32 and it is formed with an opening portion 31, where the air flow passage R3 reaching the discharge electrode 21 is formed to have one direction or a plurality of directions.

That is, the air flow passage R3 positioned on a lower side of the radiating unit 24 communicates with an opening portion 31 positioned below the discharge electrode 21, so that the air drifting from the opening portion 31 in the first branched flow passage R4 contains ionic mist generated at the discharge electrode 21 to be discharged from the discharge port 6 to the outside. A direction of airflow in the air flow passage R3 is determined by, for example, the shapes of the housing 2, the radiating unit 24, the cover portion 32, and the like, or a set number, shapes, sizes, positions of the opening portions 31.

At this time, the cover portion 32 is provided so as to cover the discharge electrode 21 and the opposite electrode 22, and the cover portion 32 is formed such that a sidewall 32c thereof surrounds an end plate 32b formed with an opening portion 32a at a portion thereof corresponding to a back side of the opposite electrode 22, so that an opening area of the opening portion 31 is determined between a distal end of the side wall 32c and a proximal end (a downstream side of the air flow passage R3) of the radiating unit 24.

The cover portion 32 guides airflow from the first branched flow passage R4 toward the opening portion 32a of the end plate 32b such that it can be avoided that the air introduced from the opening portion 31 directly strikes on the discharge electrode 21 as much as possible.

In the present embodiment, the discharge side of the second branched flow passage R5 communicates with the main air flow passage in the main block 10.

That is, as shown in FIG. 4, the second branched flow passage R5 is formed to be branched from the first branched flow passage R4 at a distal end of the lower side wall 32c of the cover portion 32 to pass through a clearance 33 between the housing 2 and an outer peripheral wall 12a of the heater 12, and to join the main air flow passage R1 at a terminal end portion of the heater 12.

With this configuration, according to the dryer 1 of the present embodiment, since the electrostatic atomization block 20 is disposed in the radiation flow passage R2 branched from the main air flow passage R1 extending from the fan 11 toward the heater 12 in the main unit block 10, the air around the discharge electrode 21 in the electrostatic atomization block 20 is always ventilated, so that water droplets condensed on the discharge electrode 21 by the cooling unit 23 can be easily generated.

Since the section of the radiation flow passage R2 positioned at the downstream side of the radiating unit 24 is branched into the first branched flow passage R4 passing through the discharge electrode 21 to communicate with the outside and the second branched flow passage R5 bypassing the discharge electrode 21 to communicate with the outside, portion of airflow in the discharge flow passage R2 flows in the second branched flow passage R5, so that a volume of the air striking on the discharge electrode 21 through the first branched flow passage R4 can be reduced, and a generation capacity of the discharge electrode 21 for generating nanometer-sized mist can be prevented from lowering due to heating of the discharge electrode 21.

Furthermore, since the air supply adjusting unit 30 is provided in the first branched flow passage R4, a direction and a volume of the air reaching the discharge electrode 21 can be adjusted by the air supply adjusting unit 30, so that stability of generation of nanometer-sized mist can be improved.

Further, since the air supply adjusting unit 30 sets the air flow passage R3 reaching the discharge electrode 21 to one direction or a plurality of directions, the influence of the air reaching the discharge electrode 21 can be finely controlled.

Further, since the discharge side of the second branched flow passage R5 is caused to communicate with the main air flow passage R1 in the main unit block 10, the air thermally influenced by the radiating unit 24 can be discharged efficiently without keeping the same around the electrostatic atomization block 20, so that the discharge electrode 21 can be cooled efficiently.

### Second Embodiment

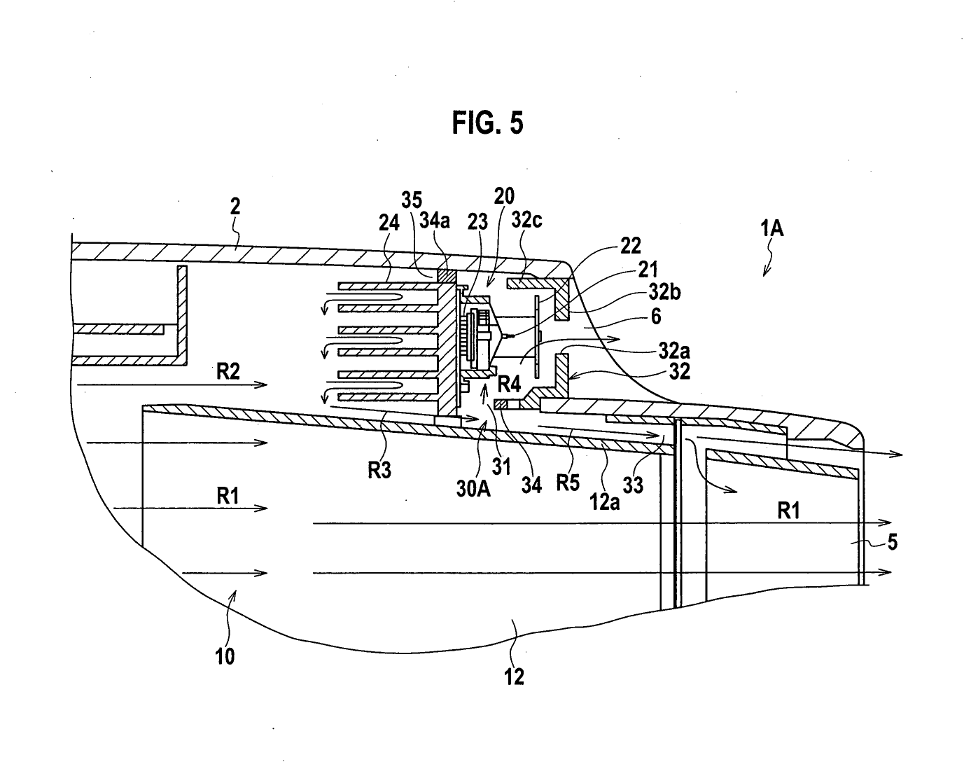

FIG. 5 is an enlarged sectional view of relevant parts of a dryer according to a second embodiment, in the similar view of FIG. 4. The dryer according to this embodiment has constituent elements identical to those of the dryer according to the first embodiment. Therefore, these identical constituent elements are denoted with like reference numerals, and redundant explanations therefor will be omitted.

As shown in FIG. 5, a dryer 1A according to the present embodiment has a configuration basically identical to the dryer 1 of the first embodiment, where the electrostatic atomization block 20 is disposed in the radiation flow passage R2 branched from the main air flow passage R1, a section of the radiation flow passage R2 positioned at the downstream side of the electrostatic atomization block 20 is branched to the first branched flow passage R4 and the second branched flow passage R5, and an air supply adjusting unit 30A that adjusts a direction and a volume of the air reaching the discharge electrode 21 is provided in the first branched flow passage R4.

In the present embodiment, the air supply adjusting unit 30A includes a first shielding member 34 and a second shielding member 34a that partially close the air flow passage R3 reaching the discharge electrode 21.

That is, the first shielding member 34 is attached so as to elongate a distal end of the lower side wall 32c of the cover member 32, so that an opening area of the opening portion 31 through which the first branched flow passage R4 is introduced can be adjusted by the first shielding member 34.

The second shielding member 34a closes a clearance 35 between an upper portion of the radiating unit 24 and the housing 2 that surrounds the radiating unit 24 and defines the radiation flow passage R2 to restrict the air striking on the discharge electrode 21 to the air flowing through the first branching flow passage R4 extending from the lower opening portion 31. It is desirable that the second shielding member 34a is made from elastic material such as felt.

According to the dryer 1A of the present embodiment, therefore, the direction and the volume of the air striking on the discharge electrode 21 can be adjusted by the first and second shielding members 34 and 34a. That is, when a plurality of opening portions 31 are present in a plurality of directions, other than at a position below the discharge electrode 21, there can be a case that flow of the air around the discharge electrode 21 becomes unstable and a direction of ionic mist generated in the electrostatic atomization block 20 does not coincide with a blowing direction of the air discharged from the main unit block 10. In this embodiment, however, the discharge direction of ionic mist can be made to coincide with the blowing direction of the main unit block 10 by adjusting the direction and the volume of the air striking on the discharge electrode 21 utilizing the first and second shielding members 34 and 34a.

Further, the first shielding member 34 can prevent the air introduced from the opening portion 31 from directly striking on the discharge electrode 21 to suppress lowering of cooling effect of the discharge electrode 21 obtained by the cooling unit 23, and suppress lowering the rate of generation of water droplets.

While the above embodiment has been explained as an example of the present invention, the invention is not limited thereto, and other various embodiments can be adopted without departing from the scope of the present invention.

For example, when a main unit block and an electrostatic atomization block similar to those described above are provided, the present invention can be embodied as other hot-air blowers, such as a fan heater.

What is claimed is:

1. A hot-air blower comprising:
a main unit block having a blowing unit that takes external air from the intake port to discharge the same from the discharge port, and a heating unit that heats air at a downstream side of the blowing unit; and
an electrostatic atomization block having a discharge electrode and an opposite electrode that are in pairs, a cooling unit that cools the discharge electrode to make water dew condensed, and a radiating unit that radiates heat from the cooling unit, where water held on the discharge electrode is atomized by applying high voltage between the discharge electrode and the opposite electrode, wherein
blowing of hot air can be made possible by the main unit block, and generation of ionic mist is made possible by the electrostatic atomization block, and wherein
a radiation flow passage facing the radiating unit is branched from a main air flow passage extending from the blowing unit of the main unit block toward the heating unit, and
the radiation flow passage is branched to a first branched flow passage passing through the discharge electrode to communicate with outside and a second branched flow passage bypassing the discharge electrode to communicate with the outside.

2. The hot-air blower according to claim 1, wherein
an air supply adjusting unit that adjusts a direction and a volume of air reaching the discharge electrode is provided in the first branched flow passage.

3. The hot-air blower according to claim 2, wherein
the air supply adjusting unit sets an air flow passage reaching the discharge electrode to one direction or a plurality of directions.

4. The hot-air blower according to claim 2, wherein
the air supply adjusting unit is a shielding member that partially closes an air flow passage reaching the discharge electrode.

5. The hot-air blower according to claim 1, wherein
a discharge side of the second branched flow passage communicates with the main air flow passage in the main unit block.
